(19) United States
(12) Patent Application Publication
(10) Pub. No.: US 2026/0367326 A1
(43) Pub. Date: Nov. 19, 2026

(54) METHOD FOR PRODUCING AN OPTICAL WAVEGUIDE AND OPTICAL WAVEGUIDE

(71) Applicant: ams-OSRAM International GmbH, Regensburg (DE)

(72) Inventors: Christian SCHOERNER, Regensburg (DE); Jakob Wilhelm HINUM-WAGNER, GRAZ (AT); Desiree RIST, GRAZ (AT)

(73) Assignee: ams-OSRAM International GmbH, Regensburg (DE)

(21) Appl. No.: 19/487,600

(22) PCT Filed: May 28, 2024
(86) PCT No.: PCT/EP2024/064588

§ 371 Date: Nov. 25, 2025

(30) Foreign Application Priority Data
May 31, 2023 (DE) 102023114244.5

(51) Int. Cl. G02B 6/132; G02B 6/12; G02B 6/122; G02B 6/136

(52) U.S. Cl. CPC G02B 6/132; G02B 6/1228; G02B 6/136; G02B 2006/12173

(57) ABSTRACT

A method for producing an optical waveguide including providing a core region arranged on a bottom cladding region is provided. Furthermore, a shadow mask is arranged on a side of the core region facing away from the bottom cladding region. A second mask is deposited on the core region, wherein the second mask includes a tapered mask region. The shadow mask is removed and the second mask and partially the core region are etched, wherein the core region comprises a tapered core region.

### CROSS-REFERENCE TO RELATED APPLICATIONS

This application is a national stage entry from International Application No. PCT/EP2024/064588, filed on May 28, 2024, published as International Publication No. WO 2024/246033 A1 on Dec. 5, 2024, and claims priority to German patent application No. 10 2023 114 244.5 filed May 31, 2023, the disclosures of all of which are incorporated by reference herein in their entireties.

### FIELD

The present application relates to a method for producing an optical waveguide and an optical waveguide. In particular, the optical waveguide is configured to confine and guide electromagnetic radiation, for example light that is perceptible to the human eye.

### BACKGROUND

It is an object of the present disclosure to provide a method for producing an optical waveguide having improved optical characteristics and a reduced complexity.

A further object is to provide an optical waveguide with improved optical characteristics.

These objects are achieved by a method and a device according to the independent patent claims. Advantageous embodiments and further developments of the method and the device are the subject of the dependent patent claims and are furthermore apparent from the following description and the figures.

### SUMMARY

According to at least one embodiment of the method for producing an optical waveguide, a core region arranged on a bottom cladding region is provided in a step A). Preferably, the core region is arranged directly adjacent to the bottom cladding region. For example, the core region is arranged on top of the bottom cladding region. The core region is the region of the waveguide in which an electromagnetic wave is at least partially confined and guided along a path of propagation. In particular, the core region has a higher refractive index than the bottom cladding region.

The bottom cladding region is, for example, formed with a silicon oxide. Preferably, the bottom cladding region is formed with silicon dioxide. In particular, the bottom cladding region is deposited on a mechanically self-supporting substrate. The substrate can be formed with silicon. The bottom cladding region is preferably formed by Plasma-Enhanced Chemical Vapor Deposition (short: PECVD) or High-Density Plasma Chemical Vapor Deposition (short: HDP-CVD). Further, the bottom cladding region particularly has a thickness of at least 2 μm. Preferably, the bottom cladding region is polished by Chemical Mechanical Polishing (short: CMP) before the core region is deposited. This ensures an advantageously smooth interface between the core region and the bottom cladding region.

According to at least one embodiment of the method for producing an optical waveguide, a shadow mask is arranged on a side of the core region facing away from the bottom cladding region in a step B). Advantageously, the shadow mask can be laterally aligned relative to the bottom cladding layer with lithographic precision. A shadow mask is a mask which comprises a structure that casts a shadow when illuminated from a top side. For example the shadow mask comprises an undercut in the form of an overhang at an edge.

According to at least one embodiment of the method for producing an optical waveguide, a second mask is deposited on the core region, wherein the second mask comprises a tapered mask region in a step C). By means of the shadow mask, the deposition of the second mask is at least partially reduced in regions where the shadow mask casts a shadow when illuminated from a top view. In particular, the region where the shadow mask casts a shadow when illuminated from a top view generates the tapered mask region. Thus, the tapered mask region inter alia is a result of the presence of the shadow mask. A thickness of the second mask increases with increasing distance from the shadow mask. A thickness is to be understood as an extension in a vertical direction. The vertical direction is oriented transverse to a main plane of extension of the optical waveguide and parallel to a stacking direction of the optical waveguide. A shadow effect also exists in lateral regions slightly outside of the shadow mask. Thus the tapered mask region can also extend outside of the area which is shadowed by the overhang of the shadow mask.

According to at least one embodiment of the method for producing an optical waveguide, the shadow mask is removed in a step D). Particularly, the shadow mask and the material of the second mask attached to the shadow mask are removed together. In particular, the shadow mask is removed in a two-step removal process. For example, the shadow mask is first soaked in a first liquid and subsequently removed by rinsing with a second liquid.

According to at least one embodiment of the method for producing an optical waveguide, the second mask is etched and the core region is partially etched in a step E), wherein the core region comprises a tapered core region. In other words, the tapered mask region is transformed into a tapered core region by an etching process.

According to at least one embodiment, the method for producing an optical waveguide comprises the following steps:
A) providing a core region arranged on a bottom cladding region,
B) arranging a shadow mask on a side of the core region facing away from the bottom cladding region,
C) depositing a second mask on the core region, wherein the second mask comprises a tapered mask region,
D) removing the shadow mask, and
E) etching the second mask and partially etching the core region, wherein the core region comprises a tapered core region.

A method for producing an optical waveguide described herein is, inter alia, based on the following considerations: In a photonic integrated circuit (short: PIC), the cross-section of the optical waveguides is one of the basic design features to consider in detail for an optimized performance. Fixing the height of the core region to a single value always involves accepting a certain compromise. A common, typical example is the compromise between propagation loss and, overall, PIC footprint. A very thin core region having a low height, pushing the optical mode into the cladding material surrounding the core region, typically allows for low-loss waveguiding. However, such low-confinement waveguides need to satisfy rather large bend radii in order to avoid bend losses, thus limiting their overall footprint to rather large values. By contrast, rather thick single-mode waveguides confine the optical mode mainly within the waveguide material, allowing for tight bend radii and a compact overall footprint of the photonic integrated circuit. However, in high-confinement waveguides the optical mode has significant overlap with the waveguide sidewall roughness, thus increasing the propagation loss. Thus, low-loss and a compact footprint are typically mutually contradictory requirements for a PIC. A further clear need for an adapted core region height is also present at optical interfaces, e.g., between the PIC and optical fibers or lasers. An efficient optical coupling between the elements requires matching the optical modes of both units as accurately as possible. Also here, the core region height adds an important degree of freedom for design optimizations.

The method for producing an optical waveguide described herein is, among other things, based on the idea of using a fabrication of 3D tapered optical waveguides within photonic integrated circuits, particularly allowing the tapering of the height of the core region(s) between at least two values. A 3D tapered waveguide in particular comprises a region where a lateral extension and a vertical extension of a core region is tapered. The concept uses a special lithography process that generates a vertically tapered second mask as a sacrificial layer. Its topography is transferred into the actual waveguide material underneath it by reactive ion etching or wet etching, realizing a tapered core region thickness in defined areas.

The tapered core region can then be further laterally structured by conventional lithography techniques into structures such as RIB or strip waveguides. The combination of the tapered core region thickness with the lateral resolution given by lithography thus provides a means to fabricate 3D tapered waveguides. The invention allows an important degree of freedom to be added to the design of the overall photonic integrated circuit, i.e., varying the core region height locally on the chip to optimize the desired waveguide functionality. This eliminates the above-mentioned trade-off that designers usually need to accept in the case of a restriction to a single core region height in a waveguide.

According to at least one embodiment of the method for producing an optical waveguide, the shadow mask comprises an overhang region. In particular, the overhang region protrudes over a region of the shadow mask arranged adjacent to the side of the core region facing away from the bottom cladding region. For example, the overhang region is formed by an undercut in the shadow mask. The shadow mask preferably has a reduced lateral extension in the overhang region.

According to at least one embodiment of the method for producing an optical waveguide, the shadow mask comprises a central region and an overhang region, wherein the overhang region protrudes over the central region. In other words, the shadow mask has a reduced lateral extension in the central region compared to a lateral extension in the overhang region. Preferably, the overhang region protrudes over the central region in the lateral direction. The central region is in particular located in a center of the shadow mask as viewed from above the optical waveguide. The overhang region is preferably arranged circumferentially around the central region. For example, the overhang region completely surrounds the central region.

According to at least one embodiment of the method for producing an optical waveguide, the central region and the overhang region are formed with the same material. In particular, the central region and the overhang region are forming one continuous shadow mask body. The shadow mask is preferably a one-piece body. For example, there is no interface between the overhang region and the central region. According to at least one embodiment of the method for producing an optical waveguide, the overhang region has an extension of 1 μm to 20 μm, preferably of 2 μm to 15 μm and particularly preferably of 5 μm to 10 μm. The extension of the overhang region is in particular a lateral extension. In other words, the extension of the overhang region is measured in the lateral direction. In particular, the extension of the overhang region corresponds to a difference in the lateral extension of the shadow mask in the overhang region compared to the lateral extension of the shadow mask beside the overhang region.

According to at least one embodiment of the method for producing an optical waveguide the core region is formed with a nitride. For example the core region is formed with one of the following materials: silicon nitride, silicon oxinitride, aluminum nitride. The material of the core region is in particular translucent for electromagnetic radiation in the visible spectral region. Electromagnetic radiation in the visible spectral region has a wavelength between 380 nm to 780 nm. Furthermore, the material of the core region is permeable for electromagnetic radiation having a wavelength in the infrared spectral range between 700 nm and 10 μm.

According to at least one embodiment of the method for producing an optical waveguide the core region is deposited by PECVD or Low-Pressure Chemical Vapor Deposition (short: LPCVD). PECVD and LPCVD are particularly suitable methods for the deposition of nitride materials. Preferably, the core region is polished by using a CMP after the deposition of the core region and before the shadow mask is arranged on the core region. This enables a particularly smooth core region. According to at least one embodiment of the method for producing an optical waveguide, the shadow mask is formed with a negative photoresist. A negative photoresist is a type of photoresist in which the portion of the photoresist that is exposed to light becomes insoluble to a photoresist developer. The unexposed portion of the photoresist can subsequently be dissolved by the photoresist developer.

Preferably, the shadow mask is formed with a lift-off resist suitable for a subsequent lift-off process of the shadow mask. The overhang region of the shadow mask is, for example, mechanically stabilized by a subsequent temperature treatment.

According to at least one embodiment of the method for producing an optical waveguide the second mask is formed by sputtering. In a sputter process microscopic particles of a solid material are ejected from its surface, after the material itself is bombarded by energetic particles of a plasma or gas. This enables an advantageously fast deposition of material.

According to at least one embodiment of the method for producing an optical waveguide, the second mask is formed with silicon nitride. Preferably, the second mask is formed with the same material as the core region.

According to at least one embodiment of the method for producing an optical waveguide, the second mask has a thickness of 5 nm to 10 μm, preferably of 50 nm to 500 nm.

The thickness corresponds to a vertical extension of the second mask. The thickness of the second mask inter alia influences a slope of the tapered mask region. A greater thickness can result in a steeper slope.

According to at least one embodiment of the method for producing an optical waveguide, the tapered mask region has a continuous surface. Preferably, the tapered mask region has a smooth surface without any steps or cracks. A tapered mask region having a continuous surface without steps advantageously allows for a production of a core region which also has a correspondingly continuous surface.

According to at least one embodiment of the method for producing an optical waveguide, the tapered mask region has an angle of at most 30°, preferably at most 20° and particularly preferably at most 10° to a main plane of extension of the second mask. The angle of the tapered mask region can be adjusted by the thickness of the second mask and the extension of the overhang region of the shadow mask. The angle of the tapered mask region inter alia influences a corresponding angle of the tapered core region.

According to at least one embodiment of the method for producing an optical waveguide the etching of the second mask and the core region is performed by a common etch process. For example, the second mask and the core region are etched by a reactive ion etching, a wet etch process or a plasma etch process. Preferably, the second mask is formed with a material having a similar or preferably equal etch rate to the material of the core region for one common etch method. Alternatively, the etch rates of the material of the core region and the material of the second mask differ from each other. By using different etch rates, one can inter alia influence the transferring of slope from the second mask into the material of the core region. The etch rates of the second mask and the core region can be influenced by material properties, for example a difference in density, or by means of a selective etch process. Further adaptions for the etch process can be different types of etch gases, gas ratios, pressures, RF power, etching times and/or different temperatures of the core region and the second mask. The etch rates of the second mask and the core region influence an angle of the tapered core region.

According to at least one embodiment of the method for producing an optical waveguide, the tapered core region has a continuous surface. A core region having a continuous surface comprises high reflectivity with fewer optically scattering surface topographies. This allows for the design of a core region with an advantageously low damping coefficient.

According to at least one embodiment of the method for producing an optical waveguide, the tapered core region has an angle of at most 30°, preferably at most 20° and particularly preferably at most 10° to a main plane of extension of the core region. The angle of the tapered core region inter alia influences an optical damping of the tapered core region. By adjusting the angle of the tapered core region, damping of the tapered core region can advantageously be reduced.

According to at least one embodiment of the method for producing an optical waveguide, the core region is structured laterally by deposition of a third mask and a further etch step. The third mask is in particular a photoresist.

According to at least one embodiment of the method for producing an optical waveguide, the further etch step is performed at least until the bottom cladding is reached. Preferably, the core region is at least partially removed in order to achieve a lateral confinement of the optical wave in the remaining core region. In particular, the further etch step is performed over a constant time.

According to at least one embodiment of the method for producing an optical waveguide the steps B)-E) are repeated in order to generate a core region comprising more than two heights. In particular, the steps B)-E) are repeated at least three times in order to generate a core region having four different heights. For example, the core region can comprise a plurality of tapered core regions having different shapes. In particular, different tapered core regions can have different slopes and angles. Alternatively, only steps B)-D) are repeated. This can result in a second mask having a profile comprising more than two different heights which are subsequently transferred to the core region in the etch step of step E).

According to at least one embodiment of the method for producing an optical waveguide, the method is simultaneously performed at a plurality of optical waveguides at wafer level. Thus, a plurality of optical waveguides can be produced in an advantageously efficient way.

An optical waveguide is also disclosed. The method for producing an optical waveguide described herein is particularly suitable for producing an optical waveguide. This means that all features disclosed in connection with the optical waveguide are also disclosed for the method for producing an optical waveguide and vice versa.

According to at least one embodiment the optical waveguide comprises a bottom cladding and a core region, wherein the core region comprises a tapered core region produced by a method according to at least one of the preceding embodiments, wherein the tapered core region has a continuous surface. In particular, the tapered core region has a smooth surface without any steps or cracks.

An optical waveguide described herein is particularly suitable for use in photonic integrated circuits which are used, for example, in visualization light source units and sensors for augmented reality applications or in LIDAR applications.

Further advantages and advantageous designs and further developments of the method for producing an optical waveguide will become apparent from the following exemplary embodiments, which are described below in association with the figures.

### BRIEF DESCRIPTION OF THE DRAWINGS

In the figures:

FIGS. 1A and 1B show schematic cross-sectional views of an optical waveguide described herein according to a first exemplary embodiment, and

FIGS. 2A to 2I show schematic cross-sectional views of an optical waveguide described herein according to a second exemplary embodiment in different stages of a method for its production.

### DETAILED DESCRIPTION

Identical, similar or equivalent elements are marked with the Same reference signs in the figures. The figures and the proportions of the elements represented in the figures among each other are not to be considered as true to scale. Rather, individual elements may be oversized for better representability and/or comprehensibility.

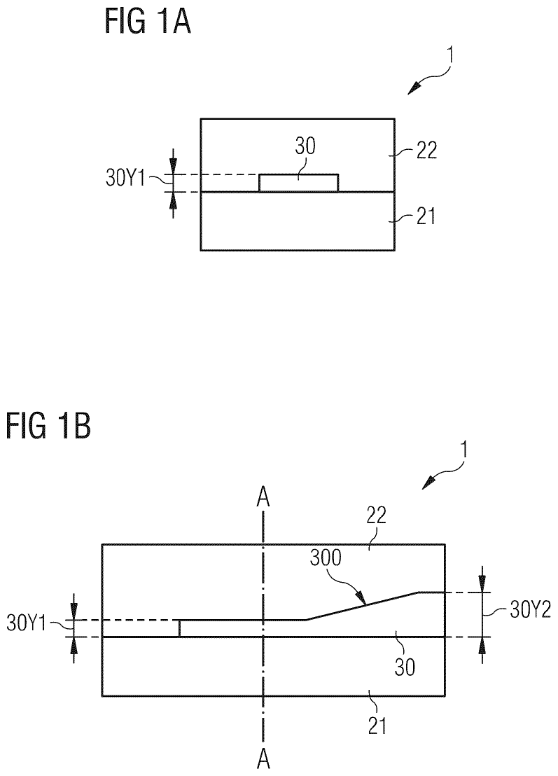

FIGS. 1A and 1B show schematic cross-sectional views of an optical waveguide 1 described herein according to a first exemplary embodiment.

FIG. 1A shows a cross-sectional view of the optical waveguide 1 along the cut line AA of the FIG. 1B. The optical waveguide 1 comprises a bottom cladding region 21, a top cladding region 22 and a core region 30. The core region 30 is at least partially surrounded by the bottom cladding region 21 and the top cladding region 22. The core region 30 has a higher refractive index than the bottom cladding region 21 and the top cladding region 22. The bottom cladding region 21 and the top cladding region 22 are formed with the same material. For example, the bottom cladding region 21 and the top cladding region 22 are formed with silicon dioxide. Alternatively, the bottom cladding region 21 and the top cladding region 22 are formed with different kinds of oxides.

FIG. 1B shows a further cross-sectional view of the optical waveguide 1 in a direction perpendicular to the cross-sectional view of FIG. 1A. The core region 30 comprises a tapered core region 300. The tapered core region 300 has a continuous surface without any steps. A thickness of the core region 30 varies in a continuous way between a first height 30Y1 and a second height 30Y2. Furthermore, the core region 30 can also comprise more than two different heights 30Y1, 30Y2 and a plurality of tapered core regions 300 which connect the different core regions 30 having different heights with each other.

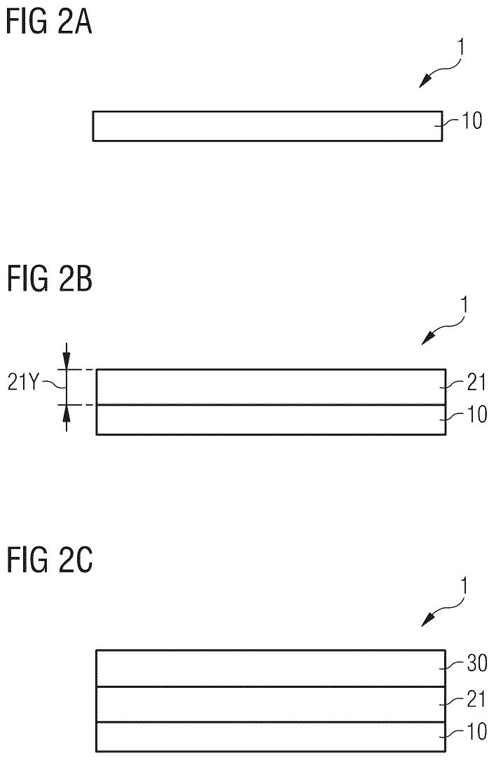

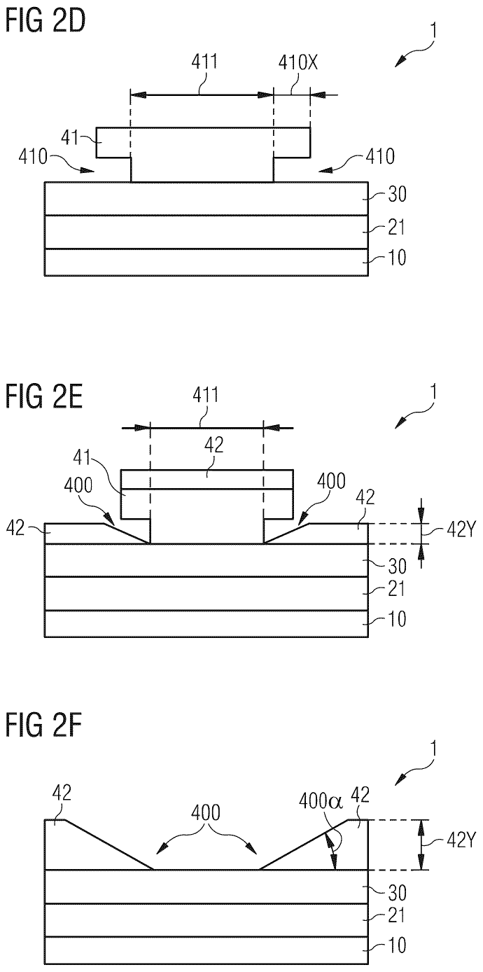

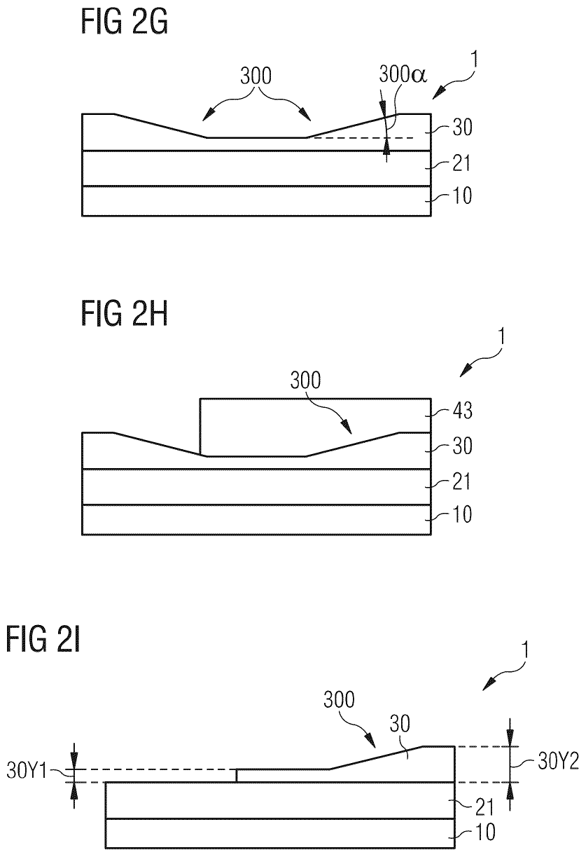

FIGS. 2A to 2I show schematic cross-sectional views of an optical waveguide 1 described herein according to a second exemplary embodiment in different stages of a method for its production.

FIG. 2A shows a step of the method for producing an optical waveguide 1 in which a substrate 10 is provided. The substrate 10 is mechanically self-supporting. For example, the substrate 10 is formed with silicon. Silicon is easily available and, given an appropriate thickness of a bottom cladding region 21 on top of the substrate 10, advantageously does not interfere with the evanescent fields of electromagnetic waves guided in the core region 30.

FIG. 2B shows a step of the method for producing an optical waveguide 1 in which a bottom cladding region 21 is deposited on the substrate 10. The bottom cladding region 21 has a thickness 21Y of at least 2 μm in order to reduce leakage losses caused by an interaction of the evanescent field propagating in the core region 30 and the substrate 10.

The bottom cladding region 21 is formed with silicon dioxide. The bottom cladding region 21 is, for example, deposited by a PECVD process or a HDP-CVD method which allows for prior CMOS integration without risking failure of the CMOS circuits.

Preferably, the bottom cladding region 21 is polished by Chemical Mechanical Polishing (short: CMP) before the core region 30 is deposited. This ensures an advantageously smooth interface between the core region 30 and the bottom cladding region 21.

Alternatively, the bottom cladding region 21 can be formed by a wet thermal silicon oxide process. A bottom cladding region 21 which is formed as a wet thermal silicon oxide has the benefit of having a very smooth surface and a highly uniform thickness 21Y distribution across the whole substrate 10.

FIG. 2C shows a step of the method for producing an optical waveguide 1 in which a core region 30 is deposited on a side of the bottom cladding region 21 facing away from the substrate 10. The core region 30 is formed with silicon nitride. The deposition of the core region 30 is performed by PECVD or LPCVD. A PECVD process is advantageously compatible with a previous CMOS process. On the other hand, a PECVD process can also incur greater optical losses in the core region 30 due to precursor residuals and a rougher surface of the core region 30. Preferably, the core region 30 is polished by Chemical Mechanical Polishing (short: CMP) before the shadow mask 41 is deposited. This ensures an advantageously smooth surface of the core region 30.

FIG. 2D shows a step of the method for producing an optical waveguide 1 in which a shadow mask 41 is arranged on the core region 30 on a side which is remote from the substrate 10. The shadow mask 41 is arranged directly on the core region 30. The shadow mask 41 is formed with a negative photoresist. A negative photoresist is a type of photoresist in which the portion of the photoresist that is exposed to light becomes insoluble to a photoresist developer. The unexposed portion of the photoresist can be subsequently dissolved by the photoresist developer.

The shadow mask 41 comprises an undercut in the form of an overhang 410 at an edge. Particularly, the shadow mask 41 comprises an overhang region 410 at each lateral end. The overhang region 410 laterally protrudes over the end of the shadow mask 41 which is adjacent to the core region 30.

In particular, the overhang region 410 protrudes over a region of the shadow mask 41 arranged adjacent to the side of the core region 30 facing away from the bottom cladding region 21. The overhang region 410 is formed by an undercut in the shadow mask 41. Thus, the shadow mask 41 has a reduced lateral extension 410X in the overhang region 410.

The overhang region 410 has an extension 410X of 1 μm to 20 μm, preferably of 2 μm to 15 μm and particularly preferably of 5 μm to 10 μm. The extension 410X of the overhang region 410 is measured in the lateral direction. In particular, the extension 410X of the overhang region 410 corresponds to a difference in the lateral extension of the shadow mask 41 in the overhang region 410 compared to the lateral extension of the shadow mask 41 beside the overhang region 410.

In particular, the shadow mask 41 comprises a central region 411 and an overhang region 410. The central region 411 is located in a center of the shadow mask 41 as viewed from above the optical waveguide 1. The overhang region 410 is arranged circumferentially around the central region 411. In particular, the overhang region 410 completely surrounds the central region 411. The shadow mask 41 has a reduced lateral extension in the central region 411 compared to a lateral extension 410X in the overhang region 410. The overhang region 410 protrudes over the central region 411 in the lateral direction.

The central region 411 is preferably formed with the same material as the overhang region 410. In particular, the central region 411 and the overhang region 410 are forming one continuous shadow mask 41 body. The shadow mask 41 is a one-piece body. For example, there is no interface between the overhang region 410 and the central region 411.

FIG. 2E shows a step of the method for producing an optical waveguide 1 in which a second mask 42 is deposited on the core region 30 and the shadow mask 41 from a side remote from the substrate 10. The second mask 42 is formed with silicon nitride. Preferably, the second mask 42 is deposited by sputtering. The overhang regions 410 locally reduce the probability of the sputtered silicon nitride of the second mask 42 being deposited on the core region 30. This results in a tapered mask region 400 of the second mask 42. The second mask 42 is deposited with a thickness 42Y of 5 nm to 10 μm, preferably of 50 nm to 500 nm. The thickness of the second mask 42Y corresponds to a maximal vertical extension of the second mask 42. The thickness 42Y of the second mask 42 inter alia influences a slope of the tapered mask region 400. A greater thickness 42Y can result in a steeper slope of the tapered mask region 400.

FIG. 2F shows a step of the method for producing an optical waveguide 1 in which the shadow mask 41 is removed together with the part of the second mask 42 arranged on the shadow mask 41. Preferably, the shadow mask 41 is removed by a lift-off process. In particular, the shadow mask 41 is removed in a two-step removal process. For example, the shadow mask 41 is first soaked in a first liquid and subsequently removed by rinsing with a second liquid.

The tapered mask region 400 has an angle 400α of at most 30°, preferably at most 20° and particularly preferably at most 10° to a main plane of extension of the second mask. The angle 400α of the tapered mask region 400 can be adjusted by the thickness 42Y of the second mask 42 and the extension 410X of the overhang region 410 of the shadow mask 41. The angle 400α of the tapered mask region 400 inter alia influences a corresponding angle 300α of the tapered core region.

FIG. 2G shows a step of the method for producing an optical waveguide 1 in which a common etching process is performed. Preferably, the etch rates of the material of the core region 30 and the material of the second mask 42 differ from each other. The etch rates of the second mask 42 and the core region 30 can be influenced by material properties, for example a difference in density, or by means of a selective etch process. Further adaptions for the etch process can be different etching times, etch gas adaption and/or different temperatures of the core region and the second mask. Preferably, the etch process has a high selectivity towards the bottom cladding region 21.

By means of the etching, the topography of the second mask region 42 is transferred into the core region 30 underneath it. For example the etching is performed by reactive ion etching or wet etching, in order to realize a tapered core region 300 having a reduced thickness in defined areas. The tapered core region 300 comprises an angle 300x. The tapered core region 300 has an angle 300α of at most 30°, preferably at most 20° and particularly preferably at most 10° to a main plane of extension of the core region 30. The angle 300α of the tapered core region 300 inter alia influences optical damping of the tapered core region 30. By adjusting the angle 300α of the tapered core region 300, damping of the tapered core region 300 can advantageously be reduced.

FIG. 2H shows a step of the method for producing an optical waveguide 1 in which a third mask 43 is arranged on the core region 30. The third mask 43 is formed with a photoresist. Preferably, the third mask 43 is illuminated using a normal illumination process in order to generate a desired lateral structure of the core region 30. Alternatively, the third mask 43 is selectively illuminated in order to generate a desired lateral structure of the core region 30.

FIG. 2I shows a step of the method for producing an optical waveguide 1 in which a further etch process is performed in order to laterally structure the core region 30. The further etch step is performed at least until the bottom cladding region 21 is reached. Preferably, the core region 30 is at least partially removed in order to achieve a lateral confinement of the optical wave in the remaining core region 30. The core region 30 may, at least in places, be removed completely. In particular, the further etch step is performed over a constant time.

According to at least one embodiment of the method for producing an optical waveguide 1 the steps B)-E) as shown in FIGS. 2D to 2G are repeated in order to generate a core region 30 comprising more than two heights 30Y1, 30Y2. For example, the core region 30 can comprise a plurality of tapered core regions 300 having different shapes. In particular, different tapered core regions 300 can have different slopes and angles.

The invention described herein is not limited by the description given with reference to the exemplary embodiments. Rather, the invention encompasses any novel feature and any combination of features, including in particular any combination of features in the claims, even if this feature or this combination is not itself explicitly indicated in the claims or exemplary embodiments.

1. A method for producing an optical waveguide comprising:
A) providing a core region arranged on a bottom cladding region,
B) arranging a shadow mask on a side of the core region facing away from the bottom cladding region, wherein
the shadow mask comprises an overhang region and is formed with a negative photoresist,
C) depositing a second mask on the core region wherein the second mask comprises a tapered mask region,
D) removing the shadow mask, and
E) etching the second mask and partially etching the core region, wherein the core region comprises a tapered core region.

2. The method for producing an optical waveguide according to claim 1, wherein
the shadow mask comprises a central region, wherein the overhang region protrudes over the central region.

3. The method for producing an optical waveguide according to claim 2, wherein
the central region and the overhang region are formed with the same material.

4. The method for producing an optical waveguide according to claim 1, wherein
the overhang region has an extension of 1 μm to 20 μm, preferably of 2 μm to 15 μm and particularly preferably of 5 μm to 10 μm.

5. The method for producing an optical waveguide according to claim 1, wherein
the core region is formed with a nitride.

6. The method for producing an optical waveguide according to claim 1, wherein
the core region is deposited by PECVD or LPCVD.

7. The method for producing an optical waveguide according to claim 1, wherein
the second mask is formed by sputtering.

8. The method for producing an optical waveguide according to claim 1, wherein
the second mask is formed with silicon nitride.

9. The method for producing an optical waveguide according to claim 1, wherein
the second mask has a thickness of 5 nm to 10 μm, preferably of 50 nm to 500 nm.

10. The method for producing an optical waveguide according to claim 1, wherein
the tapered mask region has a continuous surface.

11. The method for producing an optical waveguide according to claim 1, wherein
the tapered mask region has an angle of at most 30°, preferably at most 20° and particularly preferably at most 10°to a main plane of extension of the second mask.

12. The method for producing an optical waveguide according to claim 1, wherein
the etching of the second mask and the core region is performed by a common etch process.

13. The method for producing an optical waveguide according to claim 1, wherein
the tapered core region has a continuous surface.

14. The method for producing an optical waveguide according to claim 1, wherein
the tapered core region has an angle of at most 30°, preferably at most 20° and particularly preferably at most 10° to a main plane of extension of the core region

15. The method for producing an optical waveguide according to claim 1, wherein
the steps B)-E) are repeated in order to generate a core region comprising more than two heights.

16. An optical waveguide comprising,
a bottom cladding and a core region, wherein
the core region comprises a tapered core region produced by a method according to claim 1, wherein the tapered core region has a continuous surface.
